(19) United States
(12) Patent Application Publication
(10) Pub. No.: US 2026/0294178 A1
(43) Pub. Date: Oct. 1, 2026

(54) DISPENSER FOR DISPENSING A FLUID

(71) Applicant: APTAR ITALIA S.P.A., San Giovanni Teatino (CH) (IT)

(72) Inventors: Luigi PUGLIELLI, Sulmona (AQ) (IT); Annalisa DI CREDICO, Montesilvano (PE) (IT)

(21) Appl. No.: 19/489,043

(22) PCT Filed: May 23, 2024
(86) PCT No.: PCT/IB2024/055035

§ 371 Date: Dec. 1, 2025

(30) Foreign Application Priority Data
Jun. 15, 2023 (IT) 102023000012276

(51) Int. Cl. A47K 5/12; B65D 1/02; F04B 9/14

(52) U.S. Cl. CPC A47K 5/12; B65D 1/0207; B65D 1/0246; F04B 9/14

(57) ABSTRACT

Described is a dispenser (1) for dispensing a fluid contained in a bottle, comprising a connecting element (2) which can be screwed to the bottle, a suction and pumping apparatus (3) configured for drawing a fluid from the bottle and a dispensing head (4) which can be pressed by a user to allow the outflow of the fluid through an outlet channel (5). The connecting element (2) comprises at least one flexible profile (6), defined along a circular sector of the connecting element (2). The dispenser (1) also comprises at least one rib (7) extending at least partly inside the circular sector of the connecting element (2). The rib (7) being movable, in use by a relative rotation of the dispensing head (4) with respect to the connecting element (2), in contact against the flexible profile (6) in such a way as to deform the latter.

This invention relates to a dispenser for dispensing fluid.

The term “dispenser” refers to a dispensing device applicable to the neck of a bottle for dispensing the fluid contained in it, for example detergent substances or liquid soap.

Whilst on the one hand these dispensers must allow dispensing of the product, on the other hand they are designed to guarantee the sealing of the package on which they are applied, in a condition of non-use of the package.

In order to prevent accidental leaks of product, for example due to inadvertent operation of the dispenser, the dispensers on the market are equipped with locking systems, often achieved by rotating a dispensing button, or alternatively an element integral with it which enables/disables its sliding downwards, thus determining the dispensing of the product.

Whilst on the one hand this feature allows the risk of accidental leaks of product to be prevented, on the other hand it is not at all effective if the aim is to guarantee the security of the package to protect the integrity of the contents prior to purchasing, because the simple positioning of the dispenser button in the closed configuration cannot exclude previous dispensing of product.

Currently, systems for signalling tampering, shown in the prior art, are generally achieved by the addition of removable parts.

However, the use of additional parts contrasts with the new needs for producing packages with a low environmental impact and especially easy to dispose of at the end of use.

A need often expressed by operators in the sector is that of having dispensers equipped with tamper-evident devices having two fundamental requirements: that of not adding components which increase the weight of the material used, and also that of not dispersing, but of storing “on board” any accessory parts used as removable seals.

The technical purpose of the invention is therefore to provide a dispenser for dispensing a fluid which is able to overcome the drawbacks of the prior art. The aim of the invention is therefore to provide a dispenser for dispensing fluid which has a locking system for dispensers, applicable to bottles or the like, which can highlight previous uses of the dispenser (tamper-evident).

A further aim of the invention is to provide a dispenser for dispensing fluid which has a locking system for dispensers with a tamper-evident function which is able to preserve the outer shapes of the product so as not only to not influence the appearance of the final product, but also its functionality and resistance, minimising at the same time the use of material.

Lastly, the aim of the invention is therefore to provide a dispenser for dispensing fluid which has a locking system for dispensers with a tamper-evident function which does not use removable accessory parts to be disposed of separately.

The technical purpose indicated and the aims specified are substantially achieved by a dispenser for dispensing a fluid comprising the technical features described in one or more of the appended claims. The dependent claims correspond to possible embodiments of the invention.

Further features and advantages of the invention are more apparent in the non-limiting description which follows of a non-exclusive embodiment of a dispenser for dispensing a fluid.

The description is set out below with reference to the accompanying drawings which are provided solely for purposes of illustration without restricting the scope of the invention and in which:

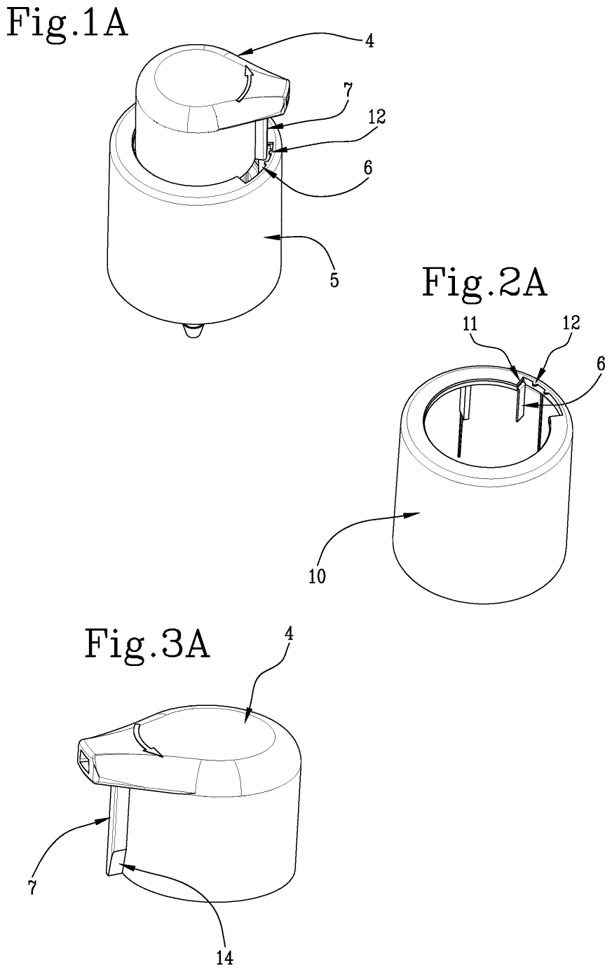

FIG. 1A is a schematic perspective view of a first possible embodiment of a dispenser according to the invention;

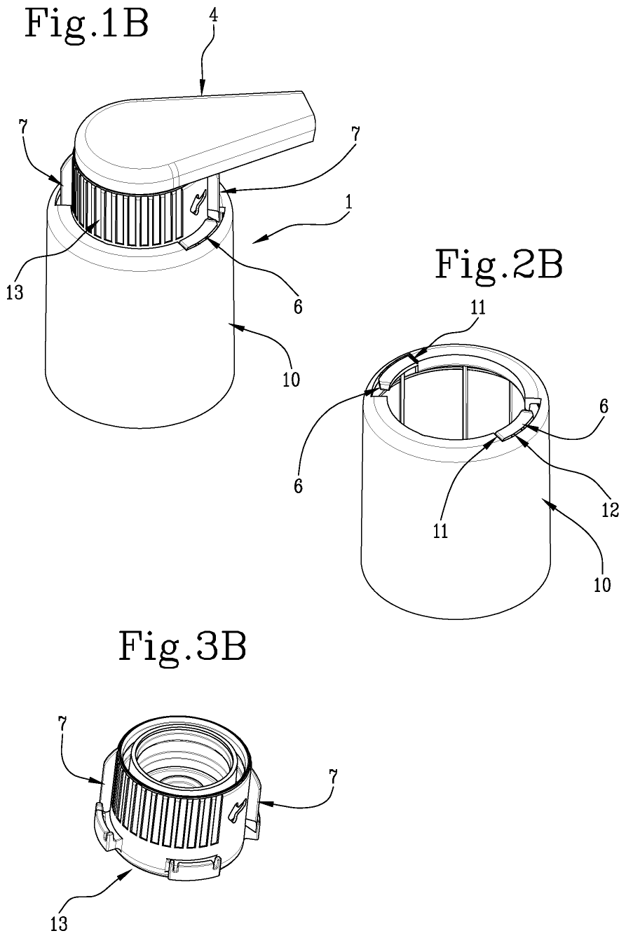

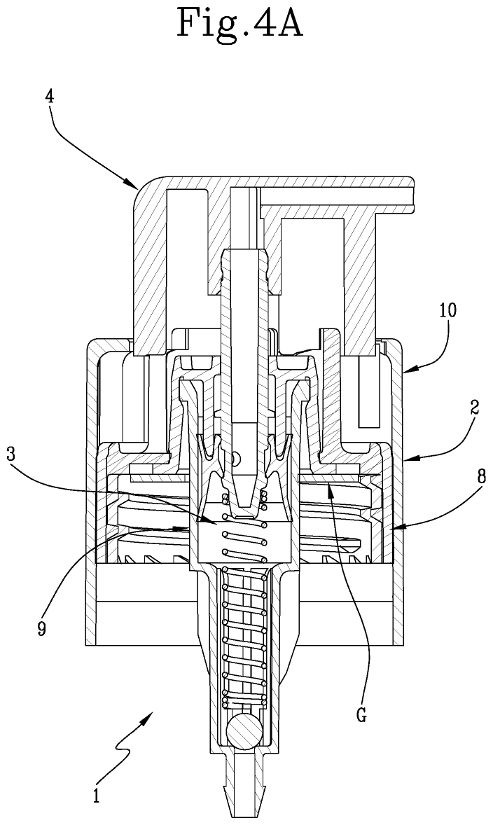

FIGS. 2A and 3A are schematic representations of some components of FIG. 1A;

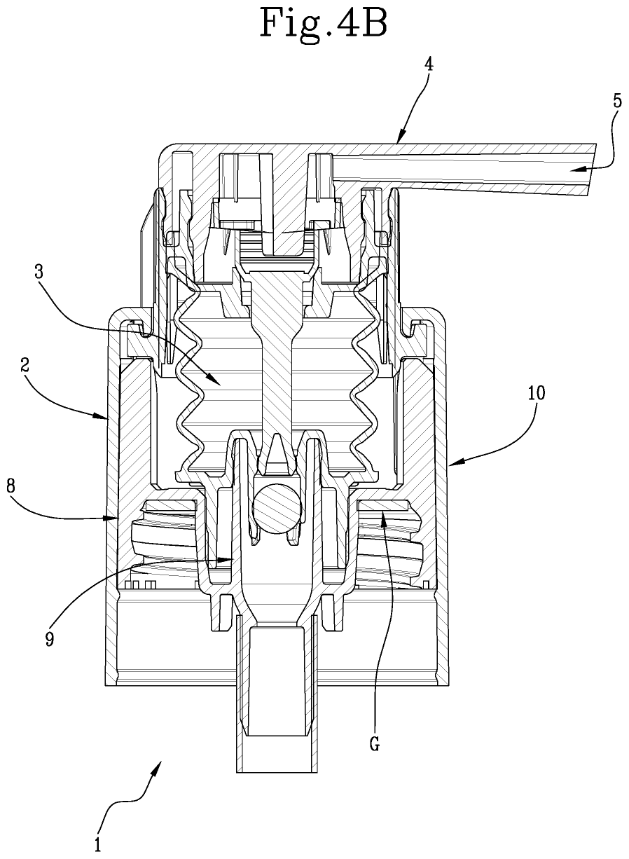

FIG. 4A is a cross section of FIG. 1A;

FIG. 1B is a schematic perspective view of a second possible embodiment of a dispenser according to the invention;

FIGS. 2B and 3B are schematic representations of some components of FIG. 1B;

FIG. 4B is a cross section view of FIG. 1B.

With reference to the accompanying drawings, the dispenser for dispensing a fluid contained in a bottle is denoted in its entirety as a dispenser 1.

The dispenser 1 comprises a connecting element 2, a suction and pumping apparatus 3 and a dispensing head 4.

The connecting element 2 comprises an assembly portion which can be screwed on the neck of a bottle and at least one flexible profile 6.

The flexible profile 6 is defined along a circular sector, in an upper portion of the connecting element 2, and has at least a first free end and at least one anchoring peripheral portion, stably fixed to the connecting element 2.

In other words, the flexible element 6 has a first portion which is disengaged, at least partly, from the connecting element 2 and at least a second portion which is stably connected and integral with the connecting element 2.

According to a possible embodiment, shown in the drawings, the connecting element 2 comprises a ring nut 8 and a collar 10, positioned externally relative to the ring nut 8 and connected to it in such a way as to transmit a rotational motion to the ring nut 8.

The collar 10 and the ring nut 8 are connected to each other by portions shaped to match each other. The first and second portions have a mainly axial extension.

In other words, the first portion of the collar 10 is inserted in a complementary fashion into the second portion of the ring nut 8.

The collar 10 is also equipped with one or more undercuts (defined in a lower portion of the collar 10) designed to improve the connection between the collar 10 and the ring nut 8.

The ring nut 8 is equipped with an assembly portion which can be screwed onto the neck of the bottle. The accompanying drawings show the fastening system made with a substantially cylindrical shape (defining the main body of the ring nut 8).

The main body of the ring nut 8 has perimeter walls (in particular a single circular lateral wall) equipped internally with a thread designed to allow the screwing to the neck of the bottle.

The threaded fastening system may be replaced by other coupling systems (not illustrated) for bottles, for example snap-on systems or the like.

In other words, the ring nut 8 has a perimeter wall, defining the main body of the ring nut 8, shaped internally according to a profile to allow the fixing on the bottle.

The dispenser 1 may also be equipped with a seal element “G”, positioned inside the perimeter wall of the ring nut 8 to guarantee the seal with the bottle.

The ring nut 8 defines (or, alternatively, is connected to) a central tubular element 9 for drawing fluid from the bottle.

In other words, the central tubular element 9, suitably shaped internally, forms an axial conduit for drawing the fluid. The central tubular element 9 is also configured to allow the coupling of a draw-up pipe (not illustrated) for sucking the fluid from the bottle.

According to a possible embodiment of a dispenser 1 for dispensing fluid, as shown in the accompanying drawings, the central tubular element 9 may have a neck in an intermediate zone.

The neck, preferably substantially having the shape of a circular ring, partly occludes the conduit, and is configured to interface with a first shutoff element.

The first shutoff element is made to be positioned resting on the neck and rise, in the case of negative pressures inside the dispenser 1, in such a way as to form together with the neck a fluid check valve.

The first shutoff element may preferably be made with a substantially spherical shape, as shown in the accompanying drawings 4A and 4B.

According to a possible embodiment, shown in the drawings, the collar 10 is circularly positioned relative to a lower portion of the dispensing head 4, and also comprises, in a relative upper portion, a flange extending radially in an internal direction. The flange of the collar 10 defines the circular sector in which the flexible profile 6 is formed.

According to an embodiment not illustrated, the dispenser 1 may not be equipped with the collar 10. The connecting element 2 comprises in this case only the ring nut 8 which integrates the upper portion of the collar 10 comprising the flange defining the circular sector in which the flexible profile 6 is made.

According to a possible embodiment, at least one flexible profile 6 is defined at least partly on the flange of the ring nut 8 and/or on the collar 10.

For example, FIGS. 2A and 2B show at least one flexible profile 6 made along one or more upper portions of the collar 10, with a free end and an end stably connected to the collar 10.

More specifically, it may be noted that there is a single flexible profile 6 in FIG. 2A and two flexible profiles 6 in FIG. 2B.

Preferably, at least one flexible profile 6 comprises a hinge 11, defined along a perimeter portion with a radial extension of the at least one flexible profile 6, opposite the first free end. Preferably, the hinge 11 represents said second end stably connected to the collar 10.

Preferably, at least one flexible profile 6 may comprise removable connecting points 12, located along a circumferential perimeter portion of the at least one flexible profile 6 defined between the first free end and the hinge 11.

The hinge 11 and the connecting points 12 define, in other words, one or more connecting points 12 between the at least one flexible profile 6 and the connecting element 2.

Inside the connecting element 2, and therefore the ring nut 8 and/or the collar 10, there is the suction and pumping apparatus 3.

The apparatus 3 is connected or connectable to the connecting element 2 and configured for drawing a fluid from the bottle.

Preferably, the suction and pumping apparatus 3 comprises a working chamber with a variable volume, for sucking and pumping a fluid drawn from the bottle.

The apparatus 3 basically has a first expanded configuration and a second compressed configuration.

The suction and pumping apparatus 3 may also comprise elastic means to favour the restoring of the first configuration of the working chamber, after it has been compressed in the second configuration by the action of a user.

Preferably, the suction and pumping apparatus 3 comprises a check valve, for selectively adjusting the inlet of the fluid in the apparatus 3, and a delivery valve for selectively adjusting the outlet of the fluid from the apparatus 3.

According to a possible embodiment, shown in FIG. 4B, the suction and pumping apparatus 3 comprises a concertina-like deformable element, defining elastic means, a lower tubular portion and a concertina-like deformable lateral wall integral with the lower tubular portion.

The concertina-like deformable lateral wall defines internally a dosing chamber of the dispenser 1 and externally a first annular space between the ring nut 8 and the concertina-like deformable lateral wall.

Preferably, the lower tubular portion is inserted inside a second annular space and coupled to the central tubular element 9 of the ring nut 8.

The dispenser 1, shown in FIG. 4B, also comprises a collection chamber, designed to collect and dispense the fluid flowing out from the dosing chamber of the concertina-like deformable element, and a central opening which places in communication the dosing chamber and the collection chamber.

According to the following embodiment, the dispenser 1 may also comprise a second shutoff element, configured to define, together with the central opening, a non-return valve which operates on the delivery of the fluid of the dosing chamber to the collection chamber.

In particular, the second shutoff element has an anchoring portion, preferably annular, designed to be stably received in a receiving portion of the dispensing head 4 in such a way as to make the second shutoff element integral with the dispensing head 4.

Moreover, the second shutoff element has a sealing portion, having a substantially elongate shape and designed to occlude the central opening, forming a closed configuration of the delivery valve.

The second shutoff element also has a connecting portion, joining the sealing portion to the anchoring portion and configured to allow the movement, by elastic deformation, of the sealing portion relative to the anchoring portion in such a way as to open the delivery valve in the case of a pressure of the dosing chamber greater than the predetermined threshold value.

According to another possible embodiment, shown in FIG. 4A, the suction and pumping apparatus 3 comprises a piston slidable inside the central tubular element 9 between a raised position and a lowered position, and a sliding hollow rod configured to control the actuation of the piston.

Preferably, the elastic means, shown in FIG. 4A, operate on the rod for opposing the free sliding of the rod and of the piston inside the apparatus 3.

In both the configurations shown in the drawing, the apparatus 3 is connected above the dispensing head 4.

In other words, the dispensing head 4 is slidably coupled to the connecting element 2 and connected below to the apparatus 3.

The dispensing head 4 is equipped with a channel designed to collect the fluid flowing out from the apparatus 3 and dispense it through an outlet channel 5.

The dispensing head 4 can also be pressed by a user to operate the apparatus 3 so as to allow the outflow of the fluid through the outlet channel 5.

According to a possible embodiment, shown in FIGS. 1B, 2B and 4B, the dispensing head 4 comprises a ring 13 configured to define, coupling with the ring nut 8, a locking system designed to define an operating configuration and a non-operating configuration.

Preferably, the use and non-use configurations can be switched by means of a rotation of the ring 13.

The term “operating configuration” means a configuration wherein the dispenser 1 can be actuated and is able to dispense the fluid drawn from the bottle.

The term “non-operating configuration” means a configuration wherein the dispenser 1 cannot be actuated and is therefore not able to dispense the fluid.

In other words, the dispensing head 4 is configured to activate and deactivate, by means of a relative rotation, a locking mechanism designed to define an operating configuration of the dispenser 1, wherein the dispensing head 4 can be pressed by a user to operate the apparatus 3 and allow the outflow of the fluid through the outlet channel 5, and a non-operating configuration of the dispenser 1, wherein the dispensing head 4 cannot be pressed to operate the apparatus 3.

In particular, the ring 13 is able to define the two above-mentioned configurations by means of a reciprocal rotation between the ring 13 and the ring nut 8.

The dispenser 1 may be controlled by a user in such a way as to allow a dispensing head 4, slidably coupled to said ring nut 8 by means of said ring 13, and connected below to said element 3, again by means of the ring 13, to adopt an operating configuration and a non-operating configuration.

According to another possible embodiment, shown in FIGS. 1A, 2A and 4A, the dispensing head 4 comprises inner profiles which can engage against suitable contact elements of the ring nut 8 to define the above-mentioned configurations of use and non-use.

More specifically, the use and non-use configurations are obtained in this case by rotating the dispensing head 4.

The dispenser 1, according to the invention, also comprises at least one rib 7 extending at least partly inside the circular sector of the connecting element 2.

The at least one rib 7 acts, in use by means of a relative rotation of the dispensing head 4, or of the ring 13, relative to the connecting element 2, in contact against the first end of the flexible profile 6 in such a way as to reduce and/or permanently deform the flexible profile 6.

Preferably, if the flexible profile 6 is connected to the connecting element 2 by the hinge 11 and/or by the connecting points 12, as in each of the configurations illustrated in the accompanying drawings, the rotation of the rib 7 determines the removal of the connecting points 12 between the at least one flexible profile 6 and the collar 10 and the simultaneous reduction of the flexible profile 6, which remains definitively deformed and connected to the collar 10 by means of the hinge 11 only.

According to a possible embodiment, shown in FIGS. 1B and 3B, at least one rib 7 extends on the ring 13.

In that case, the rib 7 is configured to enter at least once in interaction with the flexible profile 6 when the ring 13 is rotated by a user in the operating configuration of the dispenser 1.

According to a possible embodiment, shown in FIGS. 1A and 3A, the at least one rib 7 extends between a lower portion and an upper portion of the dispensing head 4.

In other words, the rib 7 extends vertically along the dispensing head 4.

According to a possible embodiment, the connecting element 2 may comprise a seat defined close to the circular sector.

The seat of the connecting element 2 is configured for receiving, in use, at least one flexible profile 6 which can be folded towards the seat following its interaction with at least one rib 7.

Preferably, at least one rib 7 comprises, on the lower end, a corner profile 14 designed to favour the interaction with the first free end of at least one flexible profile 6.

The corner profile 14 of the rib 7 makes it possible to have an angle of contact with the flexible profile 6 which facilitates the downwards deformation of the latter, and the consequent reduction of it, when the dispensing head 4, or the ring 13, rotates relative to the connecting element 2.

Advantageously, the dispenser 1 described above is able to overcome the drawbacks of the prior art.

Advantageously, the dispenser 1 described above can highlight previous uses of the dispenser (tamper-evident).

Advantageously, the dispenser 1 according to the invention is able to preserve the outer shapes of the product so as not only to influence the appearance of the final product, but also its functionality and resistance, minimising at the same time the use of material.

Advantageously, the dispenser 1 according to this invention has a locking system for dispensers with a tamper-evident function which does not use removable accessory parts to be disposed of separately.

1. A dispenser (1) for dispensing a fluid contained in a bottle, made of plastic material, comprising:
a connecting element (2) comprising an assembly portion which can be screwed on the neck of a bottle;
a suction and pumping apparatus (3) connected or connectable to said connecting element (2) and configured for drawing a fluid from said bottle;
a dispensing head (4), slidably coupled to said connecting element (2) and connected below to said apparatus (3) and equipped with a channel designed to collect the fluid flowing out from said apparatus (3) and dispense it through an outlet channel (5), said dispensing head (4) being configured for activating and deactivating, by means of a rotation of said dispensing head (4), a locking mechanism designed to define an operating configuration of the dispenser (1), wherein said dispensing head (4) can be pressed by a user to operate said apparatus (3) and allow the outflow of the fluid through said outlet channel (5), and a non-operating configuration of the dispenser (1), wherein said dispensing head (4) cannot be pressed to operate said apparatus (3);
characterised in that said connecting element (2) comprises at least one flexible profile (6), defined along a circular sector of said connecting element (2), having at least a first free end and at least one anchoring peripheral portion, stably fixed to said connecting element (2);
said dispenser (1) also comprising at least one rib (7) extending at least partly inside said circular sector of said connecting element (2);
said at least one rib (7) being active, in use, by means of said rotation of said dispensing head (4) associated with said locking mechanism, in contact against said first free end of said flexible profile (6) in such a way as to reduce and/or permanently deform said flexible profile (6).

2. The dispenser (1) according to claim 1, wherein said connecting element (2) comprises a ring nut (8) having a perimeter wall, defining the main body of the ring nut (8), shaped internally according to a profile to allow the fixing on said bottle.

3. The dispenser (1) according to claim 2, wherein said connecting element (2) comprises a collar (10), positioned outside said perimeter wall of said ring nut (8) and connected to it for transmitting, in use, a rotational motion to the ring nut (8).

4. The dispenser (1) according to claim 3, wherein said collar (10) and said ring nut (8) are connected by portions shaped to match each other with a mainly axial extension.

5. The dispenser (1) according to claim 3, wherein said collar (10) is circularly positioned relative to a lower portion of said dispensing head (4), and also comprises, in a relative upper portion, a flange extending radially in an internal direction.

6. The dispenser (1) according to claim 3, wherein said at least one flexible profile (6) is defined at least partly on said flange of said collar (10).

7. The dispenser (1) according to claim 1, wherein said dispensing head (4) comprises said at least one rib (7) extending between a lower portion and an upper portion of said dispensing head (4).

8. The dispenser (1) according to claim 1, wherein said dispensing head (4) comprises a ring (13) configured for activating and deactivating a locking system designed to define an operating configuration and a non-operating configuration in which the dispenser (1) can or cannot, respectively, be actuated for dispensing the fluid drawn from the bottle, preferably said operating and non-operating configurations being switchable by means of a rotation of said ring (13).

9. The dispenser (1) according to claim 8, wherein said at least one rib (7) extends on said ring (13) and said at least one rib (7) being configured to enter at least once in interaction with said at least one flexible profile (6) when said ring (13) is rotated by a user in said operating configuration of the dispenser (1).

10. The dispenser (1) according to claim 1, wherein said peripheral portion for anchoring said flexible profile (6), fixed stably to said connecting element (2), comprises a hinge (11) located on a second end of said circular sector, opposite a first free end.

11. The dispenser according to claim 1, wherein said flexible profile (6) is fixed to said connecting element (2) by means of one or more connecting points (12) distributed along the outer perimeter profile of said flexible profile (6) and removable following the action of said rib (7) and the consequent reduction and/or deformation of the flexible profile (6).

12. The dispenser (1) according to claim 1, wherein said connecting element (2) comprises a seat defined close to said circular sector and configured for receiving in use said at least one flexible profile (6); said at least one flexible profile (6) being foldable towards said seat following its interaction with said at least one rib (7).

13. The dispenser (1) according to claim 1, wherein said at least one rib (7) comprises an end with a corner profile (14) designed to favour the interaction with said first free end of said at least one flexible profile (6).
